(19) United States
(12) Patent Application Publication
(10) Pub. No.: US 2011/0316445 A1
(43) Pub. Date: Dec. 29, 2011

(54) LED LAMP SYSTEM

(75) Inventors: Hiroshi TERASAKA, Yokosuka-shi (JP); Hajime Osaki, Yokosuka-shi (JP); Masahiko Kamata, Yokosuka-shi (JP); Naoko Iwai, Yokosuka-shi (JP); Takeshi Saito, Ashiya-shi (JP); Hiroki Nakagawa, Ibaraki-shi (JP); Fumihiko Masuko, Hirakata-shi (JP); Tadashi Yamanaka, Ashiya-shi (JP)

(73) Assignees: TOSHIBA LIGHTING & TECHNOLOGY CORPORATION, YOKOSUKA-SHI (JP); PANASONIC CORPORATION, KADOMA-SHI (JP); PANASONIC ELECTRIC WORKS CO., LTD., KADOMA (JP)

(21) Appl. No.: 13/169,748

(22) Filed: Jun. 27, 2011

(30) Foreign Application Priority Data
Jun. 28, 2010 (JP) 2010-146875

(51) Int. Cl. H05B 37/02

(52) U.S. Cl. 315/294

(57) ABSTRACT

An LED lamp system which suppresses flickering of an LED element is provided.

The LED lamp system includes straight-tube type LED lamps each having LED elements and a dedicated power source for lighting the LED elements. The dedicated power source full-wave rectifies and smoothes a commercial AC power source, outputs constant current having a ripple factor of 1.3 or smaller and thus lights the LED elements.

### INCORPORATION BY REFERENCE

The present invention claims priority under 35 U.S.C. §119 to Japanese Patent Application No 2010-146875 filed on Jun. 28, 2010. The content of the application is incorporated herein by reference in their entirety.

### FIELD OF THE INVENTION

The present invention relates to an LED lamp system including a power source unit for supplying constant current to LED elements.

### BACKGROUND OF THE INVENTION

As disclosed in, for example, Japanese Laid-Open Patent Publication No. 2000-260573, a lamp device using LED elements each having low power consumption and a long life has been generally proposed as a light source usable in place of a straight-tube type or self-ballasted fluorescent lamp.

Recently, for renewal of a lighting fixture, there has been increased demand to attach an LED lamp to an existing lighting fixture. In consideration of lamp replacement caused by a change in lamp light color or a change in lamp output, it is preferable to attach a lamp device using LED elements to an existing fluorescent lamp lighting fixture body. Accordingly, the lamp device is lit in a manner of converting AC output of a commercial AC power supply, a fluorescent lamp lighting device or the like to DC output. Thus, when output current contains a large number of ripple components each having a variation width not smaller than a predetermined width, flickering is recognized. In particular, when a lamp device having a small total luminous flux and low iluminance is used, a user feels discomfort as a result of the flickering, thereby diminishing the function of illumination.

In view of the above problem, the present invention has been made and aims to provide an LED lamp system suppressing flickering of LED elements.

### SUMMARY OF THE INVENTION

An LED lamp system of the present invention has straight-tube type LED lamps each including LED elements. The LED lamp system has a power source unit which rectifies and smoothes alternating current, supplies constant current having a ripple factor of 1.3 or smaller to the LED elements of the straight-tube type LED lamps and lights the LED elements. Since the constant current having a ripple factor of 1.3 or smaller is supplied from the power source unit to the LED elements. so as to light the LED elements, flickering of the LED elements which is caused by pulsating current contained in output current can be suppressed.

### BRIEF DESCRIPTION OF THE DRAWINGS

FIG. 1 is a circuit diagram of an LED lamp system showing one embodiment,

FIG. 2 is a perspective view of the same LED lamp system as above,

FIG. 3 is an explanatory diagram showing a waveform of output current of the same power source unit as above, and

FIG. 4 is a table showing a relationship between a ripple factor of output current of the same power source unit as above and a percentage of subjects sensing flickering of LED elements.

### DETAILED DESCRIPTION OF THE PREFERRED EMBODIMENTS

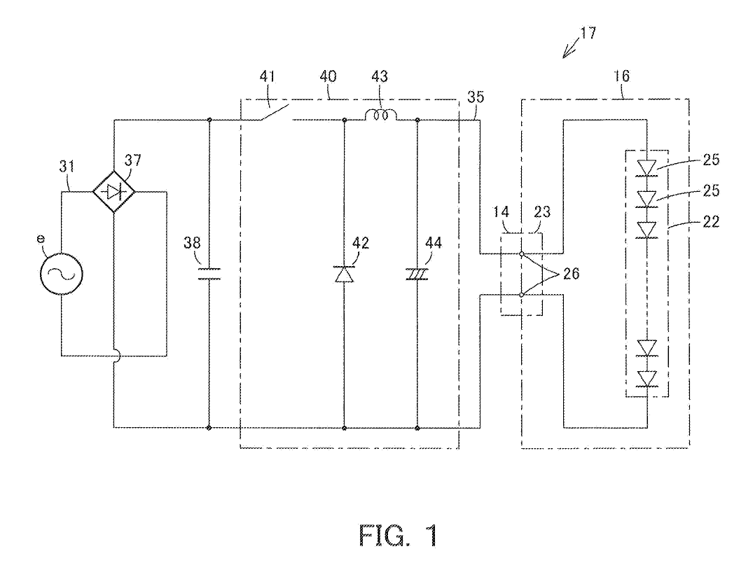

Hereinafter, one embodiment will be described with reference to FIGS. 1 to 4.

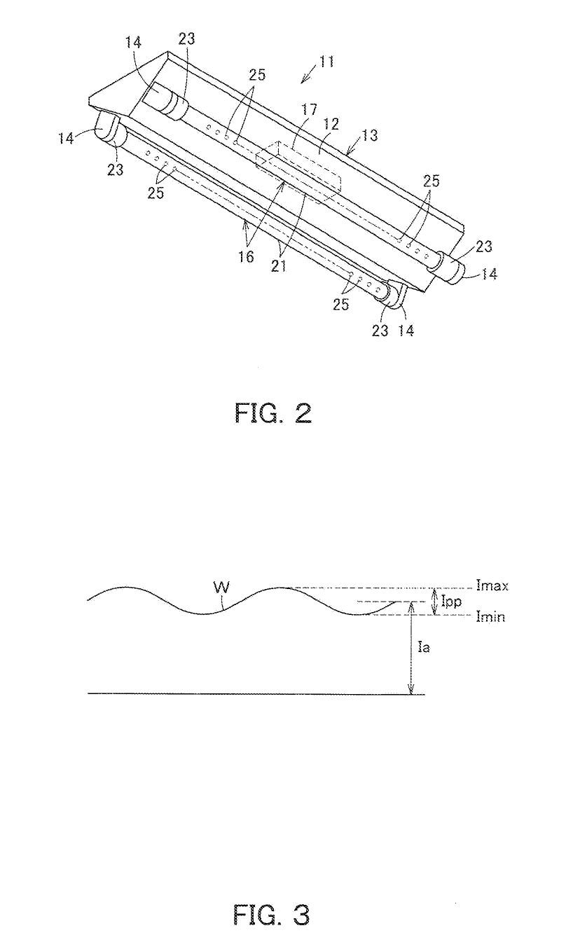

In FIG. 2, the reference numeral 11 denotes an LED lamp system, and the LED lamp system 11 is a ceiling direct mounting type lighting fixture, and includes: a fixture body 13 as a system body having a body portion (not shown) installed in a ceiling and a reflector 12 having an inverted triangular shape attached to the body portion and; a pair of sockets 14 each as a light source attaching unit disposed at both ends of the fixture body 13 so as to face each other; straight-tube type LED lamps 16 each which is connected between the pair of sockets 14 and serves as a straight-tube type light source, or an LED lamp as a lamp (straight-tube type); and a dedicated power source 17 which is lighting equipment as a power source unit (power supply circuit) for supplying power to the straight-tube type LED lamps 16 to light the straight-tube type LED lamps 16. The LED lamp system 11 is a two-light type system, two sets of the pair of sockets 14 are used and the two straight-tube type LED lamps 16 are used.

The LED lamp system 11 of the embodiment is a renewal type that uses the fixture body 13 of the existing lighting fixture using a straight-tube type fluorescent lamp and socket 14 as they are, and the straight-tube type LED lamp 16 and dedicated power source 17. Alternatively, even in the case where the LED lamp system 11 using the straight-tube type LED lamps 16 and the dedicated power source 27 is newly installed, it is installed as the LED lamp system 11 reusing the fixture body 13 and the sockets 14 of an existing lighting fixture structure using straight-tube type fluorescent lamps, and using the straight-tube type LED lamp 16 and dedicated power source 17 for the LED lamp system 11.

The straight-tube type LED lamp 16 includes, for example, a cylindrical straight-tube type tube body 21 having transmittance, a light emitting module 22 housed in the tube body 21 and connection portions 23 provided at both ends of the tube body 21.

The tube body 21 is made of glass or resin having transmittance and diffuseness, and formed in a cylindrical shape having substantially the same tube length, tube diameter and appearance as those of a straight-tube type fluorescent lamp. The connection portions 23 as an attachment portion are provided at both ends of the tube body 21.

The light emitting module 22 includes a slender substrate (not shown) along a tube axial direction of the tube body 21 and a plurality of LED elements 25 as loads mounted along a longitudinal direction of the substrate. Light maybe emitted mainly from a predetermined direction of the tube body 21 by making the substrate of the light emitting module 22 flat and mounting the LED elements 25 on one face of the flat substrate. Alternatively, light may be emitted from the whole circumference of the tube body 21 by forming the substrate in a polygonal cylindrical shape and mounting the LED elements 25 on the peripheral surface of the substrate. In the case of an LED element, for example, in the LED element 25, an LED chip emitting blue light is sealed with transparent resin containing fluorescent matter which is excited by the blue light to emit yellow light, and white light is emitted from a surface of the transparent resin.

The connection portion 23 is connected to the socket 14, made of, for example, insulating synthetic resin, formed in the same shape as that of a cap of a straight-tube type fluorescent lamp, and adhered and fixed to the end of the tube body 21. A pair of lamp pins 26 as a receiving power portion similar to a lamp pin of the straight-tube type lamp is provided in a projecting manner on an end face of the connection portion 23. Moreover, the connection portion 23 is not limited to being constituted by a pair of lamp pins 26, and may be constituted by a single lamp pin or the like. Any constitution is applicable if it can realize electric connection or support of the connection portion 23 with respect to the socket 14. Additionally, the connection portion 23 may he electrically and physically connected to the socket 14 via, for example, an adaptor.

The straight-tube type LED lamp 16 has substantially the same outer diameter and total luminous flux as those of, for example, an existing straight-tube type fluorescent lamp 40V type (FL 40 type, FHF 32 type), a total Length in a tube axial direction. of shorter than 1300 mm and 1000 mm or longer, and rated characteristics that the total luminous flux is 2000 lm or larger.

As shown in FIG. 1, a pair of power supply wires 31 for supplying a commercial Ac power source e (for example, 100V AC, 50/60 Hz) is connected to an input side of the dedicated power source 17 through the fixture body 13, and each socket 14 is connected to an output side Of the dedicated power source 17 via a connecting wire 35. Moreover, although only one of the straight-tube type LED lamps 16 is shown in FIG. 1, the other straight-tube type LED lamp 16 has the same constitution.

In this case, the dedicated power source 17 includes, for example: a full-wave rectifying element 37 such as a bridge diode for rectifying Ac power from the commercial AC power source e: a (first) smoothing element 38 such as a smoothing capacitor for smoothing output power from the full-wave rectifying element 37; and a DC-DC converter 40 including chopper circuit for converting voltage to desired voltage, etc., converts AC power having an AC sine wave or AC rectangular wave to DC power and supplies the DC power to the lamp pins 26 of the straight-tube type LED lamp 16 through the socket 14. Moreover, the dedicated power source 17 may be connected to, for example, an output side of an AC power supply such as a fluorescent lamp lighting device for outputting AC power as AE power from the commercial AC power source e.

The DC-DC converter 40 has, for example: a series circuit of a switching element 41 electrically connected between both ends of the smoothing element 38 and a diode 42 serving as a flywheel diode; and a series circuit of an inductor 43 electrically connected in parallel to the diode 42 and a (second) smoothing element 44 such as a capacitor. The switching element 41 is switching-controlled by a control unit (not shown) so as to perform step-down operation. Moreover, for example, a switching element such as a MOSFET may be used as the switching element 41.

Here, the dedicated power source 17 outputs, for example, output current (constant current) having a current waveform (lamp current envelope waveform) W shown in FIG. 3, and a ripple factor RF of the current is set in accordance with at least either switching control (a switching frequency and a duty ratio) of the switching element 41 or the capacity of the smoothing element 44. The ripple factor RF is obtained by dividing a variation width Ipp of output current of the dedicated power source 17 by a lamp current average value (effective current value) Ia (RF=Ipp/Ia), and the variation width Ipp of output current is obtained by subtracting a minimum value Imin from maximum value max of output current, (Ipp=Imax−Imin). That is, as the ripple factor RF is smaller, a pulsating current contained in output current is smaller. The ripple factor RF of the output current of the dedicated power source 17 is set to 1.3 or smaller. Moreover, according to the embodiment, in the dedicated power source 17, since a commercial AC power source e of 50/60 Hz is subjected to full-wave rectification by the full-wave rectifying element 37, the frequency of pulsating current contained in output current is 100/120 Hz, however, if the pulsating current contained in output current has a frequency not less than 100 Hz, any output current can be used as long as it responds similarly.

In the dedicated power source 17, when the control unit turns on the switching element 41 in the DC-DC converter 40, increased current flows in the inductor 43 and magnetic energy is accumulated therein, and the switching element 41 is turned off, thereby magnetic energy accumulated in the inductor 43 is discharged via the diode 42, decreased current flows and the smoothing element 44 is charged. By repeating the same circuit operation, in the embodiment, constant current having the current waveform W shown in FIG. 3, output current having a minimum value Imin of larger than 0 A (not 0 A), is output from the dedicated power source 17 and supplied to the LED elements 25 of the light emitting module 22 via the connecting wire 35, the socket 14 and the lamp pins 26 of the connection portions 23, and the LED element 25 are lit.

Since the ripple factor RI of output current of the dedicated power source 17 is here set to 1.3 or smaller, flickering of the LED element 25, in other words, change in the amount of emitted light visible to a user can be suppressed, and in particular, flickering under an environment of high illuminance can be reduced.

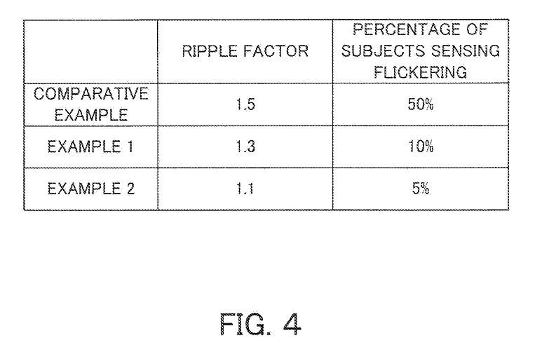

FIG. 4 shows an experimental result on whether a plurality of subjects watching lamps having different ripple factors RE sense flickering. In Example 1 and Example 2 corresponding to the above embodiment, the ripple factors RF were set to 1.3 and 1.1, respectively, in the comparative example corresponding to a prior art, the ripple factor RF was set to 1.5. As shown in FIG. 4, the comparative example reveals that 50% or more of the subjects sense flickering, Examples 1 and 2 reveal that 10% and 5% of the subjects sense flickering, respectively. That is, by setting the ripple factor RF of output current to 1.3 or smaller, flickering of the LED element 25 can be effectively suppressed.

When, in particular, the frequency of pulsating current contained in output current is in a relatively small range, for example, approximately 100 Hz, a user can detect flickering of the LED element 25 by eye and easily sense the flickering. Thus, by setting the ripple factor in the dedicated power source 17, which outputs output current containing pulsating current of 100 Hz or higher, to 1.3 or smaller, even when the LED element 25 is lit by output current containing a pulsating current having a frequency band that a user easily senses the user hardly senses flickering and discomfort caused by the flickering can be reduced.

By controlling the output current of the dedicated power source 17 so that the minimum value Imin does not reach 0 A for each cycle, he period when the LED element 25 temporarily turns off can be, realized, Thus, a user senses flickering of the LED element 25 even less.

With the LED lamp system 11 compatible with the straight-tube type LED lamps 16, the dedicated power source 17 is arranged at the fixture body 13 side, thereby the straight-tube type LED lamp 16 can be constituted at a low cost and can be easily replaced in the same manner as the existing straight-tube type fluorescent lamps. Additionally, cost in replacement of the straight-tube type LED lamp 16 can be reduced, thermal influence of the LED elements 25 on the dedicated power source 17 can be reduced, and the reliability and life of the dedicated power source 17 can be improved.

Moreover, in the embodiment, the dedicated power source 17 can be constituted so that the output voltage (output current) is set to 0V (0 A) for each cycle as long as the ripple factor RE of the current waveform W of the output current is set to 1.3 or smaller. In this case, even when arc is generated in a circuit of the straight-tube type LED lamp 16 due to, for example, detachment, contact failure or disconnection at each connection part in the circuit, output voltage (output current) to be supplied to the straight-tube type LED lamp 16 becomes 0V (0 A) for each cycle and the arc can be prevented from continuing.

As the LED lamp system 11, for example, a single lamp type lighting fixture using one pair of sockets 14 may be used, or a multiple-lamp type lighting fixture using three or more sets of the pair of sockets 14 may be used. Additionally, the LED lamp system 11 is applicable not only to a ceiling direct mounting type lighting fixture hut also to an embedding type lighting fixture, etc.

Power may be supplied to the straight-tube type LED lamp 16 via both pair of sockets 14 or only one of them. When power is supplied via only one of the sockets 14, the other socket 14 may only support an end of the straight-tube type LED lamp. 16. Alternatively, for example, a dimming signal is transmitted from the other socket 14 to the straight-tube type LED lamp 16 so that the lit LED element 25 is dimmed by a dimming circuit built in the straight-tube type LED lamp 16. Additionally, without use of the socket 14, power maybe supplied from a non-contact power supplying portion arranged at the fixture body 13 side to a non-contact power receiving portion. arranged at the straight-tube type LED lamp 16 side by a dielectric coupling method or the like. Additionally the sockets 14 may be used for supporting the straight-tube type LED 16 and another power supplying method may be used for the straight-tube type LED lamp 16.

What is claimed is:

1. An LED lamp system comprising:
straight-tube type LED lamps each including LED elements; and
a power source unit for rectifying and smoothing alternating current, supplying constant current having a ripple factor of 1.3 or smaller to the LED elements of the straight-tube type LED Lamps and lighting the LED elements.

2. The LED lamp system according to claim 1, wherein the two LED lamps are used and the power source Unit lights the LED elements of each LED lamp.

3. The LED lamp system according to claim 1, wherein the LED lamp has the same tube length and tube diameter as those of a straight-tube type fluorescent lamp.

4. The LED lamp system according to claim 1 which is a ceiling direct mounting type lighting fixture.
